(19) United States
(12) Patent Application Publication
(10) Pub. No.: US 2016/0180458 A1
(43) Pub. Date: Jun. 23, 2016

(54) MULTI-PARTY TRADE ORDER ENTRY

(71) Applicant: TRADING TECHNOLOGIES INTERNATIONAL INC., Chicago, IL (US)

(72) Inventor: Scott F. Singer, Green Oaks, IL (US)

(21) Appl. No.: 14/576,178

(22) Filed: Dec. 18, 2014

(51) Int. Cl. G06Q 40/04

(52) U.S. Cl. CPC G06Q 40/04

(57) ABSTRACT

Multi-party trade order entry is disclosed herein. An example method includes detecting a trade authorization command at a first computing device, where the trade authorization command corresponds to a trade authorization interval, and where the trade authorization interval relates to a tradeable object offered at an exchange. The example method also includes detecting a trade action command at a second computing device related to the tradeable object, comparing the trade action command to the trade authorization interval to verify the trade action command, and processing the trade action command based on receipt of the trade authorization command and the trade action command, and the verification of the trade action command.

### BACKGROUND

An electronic trading system generally includes a trading device in communication with an electronic exchange. The trading device receives information about a market, such as prices and quantities, from the electronic exchange. The electronic exchange receives messages, such as messages related to orders, from the trading device. The electronic exchange attempts to match quantity of an order with quantity of one or more contra-side orders.

In some known trading systems, a trade or transaction initiated by a trader without approval authority is typically approved after the trader has submitted the order. In such known systems, an approver (e.g., an approving trader, a supervisory trader, etc.) will review numerous trade entries listed and approve the entries on a graphic user interface (GUI) of a computer or a trading device after numerous trade entries have been submitted.

### BRIEF DESCRIPTION OF THE FIGURES

Certain embodiments are disclosed with reference to the following drawings.

FIG. 1 illustrates a block diagram representative of an example electronic trading system in which certain embodiments may be employed.

FIG. 2 illustrates a block diagram of another example electronic trading system in which certain embodiments may be employed.

FIG. 3 illustrates a block diagram of an example computing device which may be used to implement the disclosed embodiments.

FIG. 4 illustrates a flow diagram representative of example machine readable instructions that may be executed to implement disclosed embodiments.

FIG. 5 illustrates another flow diagram representative of example machine readable instructions that may be executed to implement disclosed embodiments.

FIGS. 6a-6b illustrate example trading interfaces in accordance with disclosed embodiments.

FIG. 7 illustrates a block diagram of an example system which may be employed with certain disclosed embodiments.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

This disclosure relates generally to electronic trading environments and, more particularly, to multi-party trade order entry.

When multiple traders are working together, it is sometimes necessary and desirable to place restrictions on the trading activities of one or more of the traders such as a junior trader or trainee. For example, it may be desirable to impose tighter controls on the junior trader and/or trades initiated by the junior trader such as subjecting the trading activity of an inexperienced trader to approval by a senior trader or supervisor. Typically, such an approval occurs later when a queue of trades have built up over time. In contrast, a senior trader opening a trade authorization interval for the junior trader to execute a trade may be more time-efficient than the senior trader later approving a queue of trades, as seen in typical trading systems. The example embodiments disclosed herein enable quick and efficient trade approval by pre-authorization of trades (e.g., trade commands, trade action commands, etc.) and/or initiating a trade authorization interval for the junior trader to submit, implement or initiate trade orders

Trading applications allow users to initiate and/or approve trade actions. In some examples, a trading application may include trading interface windows for displaying market data or a portion of the market data. Trading interface windows may further include trade action controls for initiating, executing or approving trade actions. A trade action control is a button, cell, or area on a trading screen that corresponds to a particular trade action, which may include a trade authorization or a trade command (e.g., a trade initiation). Trading applications may be used on a portable device or a computer, for example.

The example embodiments disclosed herein allow the senior trader to open a trade authorization interval by a trading application of a first computing device, and for the junior trader to submit a trade action command on a trading application on a second computing device within the trade authorization interval. For example, the trade authorization interval may be a time limit or a period of time in which the junior trader must submit the trade action command after the trade authorization command has been detected or received. By making the process more contemporaneous, the trade execution and/or overall trader efficiency of such a system may be improved in relation to the prior trading systems. In particular, a trade authorization command may be initiated by the senior trader interacting with a user interface (e.g., a trading application) on the first computing device by pushing a button on a touchscreen of the first computing device and while the senior trader pushes and holds the button, the junior trader submits a trade action command by pressing a button on a touch screen of a second computing device.

Although this description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways.

### I. Brief Description of Certain Embodiments

Certain embodiments provide an example method including detecting a trade authorization command at a first computing device, where the trade authorization command corresponds to a trade authorization interval, and where the trade authorization interval relates to a tradeable object offered at an exchange. The example method also includes detecting a trade action command at a second computing device related to the tradeable object, comparing the trade action command to the trade authorization interval to verify the trade action command, and processing the trade action command based on receipt of the trade authorization command and the trade action command, and the verification of the trade action command. In some examples, the trade authorization interval is an overlap in time of the trade authorization command and the trade action command. In other example embodiments, the trade authorization interval is a time limit after the trade authorization command in which the trade action command is to be transmitted or received. In yet other example embodiments, the trade authorization interval is a limit on a number of trades allowed (i.e., a threshold number of permitted trades, a number of trade actions allowed, etc.), trade volume limits, etc.

Certain embodiments provide another example method including detecting, by a first computing device, a first trade authorization command, where the first trade authorization command relates to a tradeable object offered at an exchange. The example embodiment also includes receiving, at the first computing device, a second trade authorization command related to the tradeable object, authorizing a trade action command based on the first trade authorization command and receipt of the second trade authorization command. The example embodiment also includes communicating, by the first computing device, the trade action command or authorization of the trade action command to the exchange.

Certain embodiments provide an example tangible machine readable medium having instructions stored thereon, which when executed cause a machine to detect a first trade authorization command, where the first trade authorization command relates to a tradeable object offered at an exchange, and receive or detect a second trade authorization command related to the tradeable object offered at the exchange. The example tangible machine medium having instructions stored thereon, which when executed, also cause the machine to authorize a trade action command based on the detection of the first trade authorization command and the reception or detection of the second trade authorization command, and verification of a trade authorization condition. In some embodiments, the trade authorization condition includes one or more of the following: the first trade authorization command and the second trade authorization command have an overlap in time, the first and second trade authorization commands occur within a certain time period relative to one another, or one or more of the first and second trade authorization commands is within defined trade limitations.

### II. Example Electronic Trading System

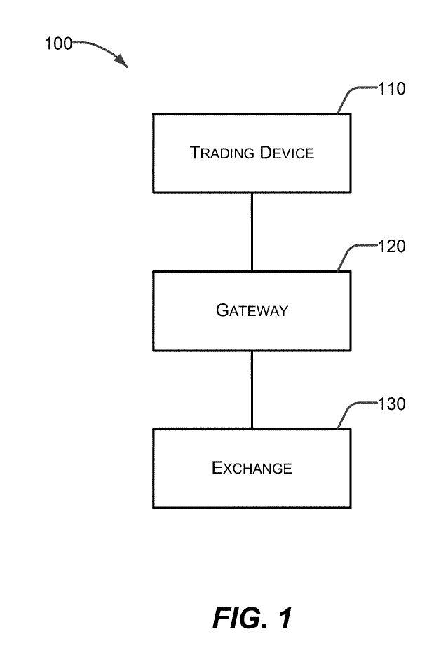

FIG. 1 illustrates a block diagram representative of an example electronic trading system 100 in which certain embodiments may be employed. The system 100 includes a trading device 110, a gateway 120, and an exchange 130. The trading device 110 is in communication with the gateway 120. The gateway 120 is in communication with the exchange 130. As used herein, the phrase “in communication with” encompasses direct communication and/or indirect communication through one or more intermediary components. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. A user may utilize the trading device 110 to monitor this market data and/or base a decision to send an order message to buy or sell one or more tradeable objects to the exchange 130.

Market data may include data about a market for a tradeable object. For example, market data may include the inside market, market depth, last traded price (“LTP”), a last traded quantity (“LTQ”), or a combination thereof. The inside market refers to the highest available bid price (best bid) and the lowest available ask price (best ask or best offer) in the market for the tradeable object at a particular point in time (since the inside market may vary over time). Market depth refers to quantities available at price levels including the inside market and away from the inside market. Market depth may have “gaps” due to prices with no quantity based on orders in the market.

The price levels associated with the inside market and market depth can be provided as value levels which can encompass prices as well as derived and/or calculated representations of value. For example, value levels may be displayed as net change from an opening price. As another example, value levels may be provided as a value calculated from prices in two other markets. In another example, value levels may include consolidated price levels.

A tradeable object is anything which may be traded. For example, a certain quantity of the tradeable object may be bought or sold for a particular price. A tradeable object may include, for example, financial products, stocks, options, bonds, future contracts, currency, warrants, funds derivatives, securities, commodities, swaps, interest rate products, index-based products, traded events, goods, or a combination thereof. A tradeable object may include a product listed and/or administered by an exchange, a product defined by the user, a combination of real or synthetic products, or a combination thereof. There may be a synthetic tradeable object that corresponds and/or is similar to a real tradeable object.

An order message is a message that includes a trade order. A trade order may be, for example, a command to place an order to buy or sell a tradeable object; a command to initiate managing orders according to a defined trading strategy; a command to change, modify, or cancel an order; an instruction to an electronic exchange relating to an order; or a combination thereof.

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, or a combination thereof. As another example, the trading device 110 may include a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass that an element, structure, or device has been modified, arranged, changed, or varied to perform a specific function or for a specific purpose.

By way of example, the trading device 110 may be implemented as a personal computer running a copy of X_TRADER®, an electronic trading platform provided by Trading Technologies International, Inc. of Chicago, Illinois (“Trading Technologies”). As another example, the trading device 110 may be a server running a trading application providing automated trading tools such as ADL®, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, a group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application stored by a trading device may be executed to arrange and display market data in one or more trading interface windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in certain configurations or operating modes of the trading application.

A trading application may be implemented utilizing computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110 from another computer readable medium. For example, the trading application (or updates to the trading application) may be stored by a manufacturer, developer, or publisher on one or more CDs or DVDs, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment which does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a cellular network, a peer-to-peer network, a T1 line, a T3 line, an integrated services digital network (“ISDN”) line, a point-of-presence, the Internet, a shared memory system and/or a proprietary network such as TTNET™ provided by Trading Technologies, for example.

The gateway 120 may include one or more electronic computing platforms. For example, the gateway 120 may be implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof.

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof.

In certain embodiments, the gateway 120 communicates with the exchange 130 using a local area network, a wide area network, a wireless network, a virtual private network, a cellular network, a peer-to-peer network, a T1 line, a T3 line, an ISDN line, a point-of-presence, the Internet, a shared memory system, and/or a proprietary network such as TTNET™ provided by Trading Technologies, for example.

The exchange 130 may be owned, operated, controlled, or used by an exchange entity. Example exchange entities include the CME Group, the London International Financial Futures and Options Exchange, the Intercontinental Exchange, and Eurex. The exchange 130 may include an electronic matching system, such as a computer, server, or other computing device, which is adapted to allow tradeable objects, for example, offered for trading by the exchange, to be bought and sold. The exchange 130 may include separate entities, some of which list and/or administer tradeable objects and others which receive and match orders, for example. The exchange 130 may include an electronic communication network (“ECN”), for example.

The exchange 130 may be an electronic exchange. The exchange 130 is adapted to receive order messages and match contra-side trade orders to buy and sell tradeable objects. Unmatched trade orders may be listed for trading by the exchange 130. Once an order to buy or sell a tradeable object is received and confirmed by the exchange, the order is considered to be a working order until it is filled or cancelled. If only a portion of the quantity of the order is matched, then the partially filled order remains a working order. The trade orders may include trade orders received from the trading device 110 or other devices in communication with the exchange 130, for example. For example, typically the exchange 130 will be in communication with a variety of other trading devices (which may be similar to trading device 110) which also provide trade orders to be matched.

The exchange 130 is adapted to provide market data. Market data may be provided in one or more messages or data packets or through a shared memory system. For example, the exchange 130 may publish a data feed to subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### III. Expanded Example Electronic Trading System

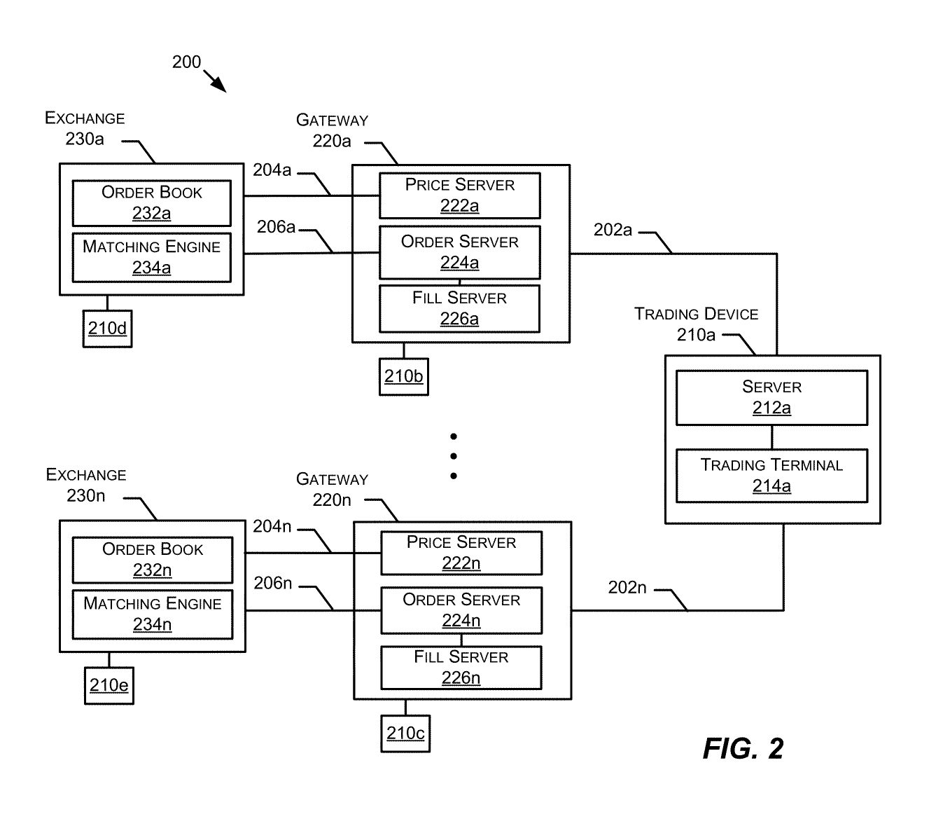

FIG. 2 illustrates a block diagram of another example electronic trading system 200 in which certain embodiments may be employed. In this example, a trading device 210 may utilize one or more communication networks to communicate with a gateway 220 and exchange 230. For example, the trading device 210 utilizes network 202 to communicate with the gateway 220, and the gateway 220, in turn, utilizes the networks 204 and 206 to communicate with the exchange 230. As used herein, a network facilitates or enables communication between computing devices such as the trading device 210, the gateway 220, and the exchange 230.

The following discussion generally focuses on the trading device 210, gateway 220, and the exchange 230. However, the trading device 210 may also be connected to and communicate with “n” additional gateways (individually identified as gateways 220a-220n, which may be similar to gateway 220) and “n” additional exchanges (individually identified as exchanges 230a-230n, which may be similar to exchange 230) by way of the network 202 (or other similar networks). Additional networks (individually identified as networks 204a-204n and 206a-206n, which may be similar to networks 204 and 206, respectively) may be utilized for communications between the additional gateways and exchanges. The communication between the trading device 210 and each of the additional exchanges 230a-230n need not be the same as the communication between the trading device 210 and exchange 230. Generally, each exchange has its own preferred techniques and/or formats for communicating with a trading device, a gateway, the user, or another exchange. It should be understood that there is not necessarily a one-to-one mapping between gateways 220a-220n and exchanges 230a-230n. For example, a particular gateway may be in communication with more than one exchange. As another example, more than one gateway may be in communication with the same exchange. Such an arrangement may, for example, allow one or more trading devices 210 to trade at more than one exchange (and/or provide redundant connections to multiple exchanges).

Additional trading devices 210a-210n, which may be similar to trading device 210, may be connected to one or more of the gateways 220a-220n and exchanges 230a-230n. For example, the trading device 210a may communicate with the exchange 230a via the gateway 220a and the networks 202a, 204a and 206a. In another example, the trading device 210b may be in direct communication with exchange 230a. In another example, trading device 210c may be in communication with the gateway 220n via an intermediate device 208 such as a proxy, remote host, or WAN router.

The trading device 210, which may be similar to the trading device 110 in FIG. 1, includes a server 212 in communication with a trading terminal 214. The server 212 may be located geographically closer to the gateway 220 than the trading terminal 214 in order to reduce latency. In operation, the trading terminal 214 may provide a trading screen to a user and communicate commands to the server 212 for further processing. For example, a trading algorithm may be deployed to the server 212 for execution based on market data. The server 212 may execute the trading algorithm without further input from the user. In another example, the server 212 may include a trading application providing automated trading tools and communicate back to the trading terminal 214. The trading device 210 may include additional, different, or fewer components.

In operation, the network 202 may be a multicast network configured to allow the trading device 210 to communicate with the gateway 220. Data on the network 202 may be logically separated by subject such as, for example, by prices, orders, or fills. As a result, the server 212 and trading terminal 214 can subscribe to and receive data such as, for example, data relating to prices, orders, or fills, depending on their individual needs.

The gateway 220, which may be similar to the gateway 120 of FIG. 1, may include a price server 222, order server 224, and fill server 226. The gateway 220 may include additional, different, or fewer components. The price server 222 may process price data. Price data includes data related to a market for one or more tradeable objects. The order server 224 processes order data. Order data is data related to a user's trade orders. For example, order data may include order messages, confirmation messages, or other types of messages. The fill server collects and provides fill data. Fill data includes data relating to one or more fills of trade orders. For example, the fill server 226 may provide a record of trade orders, which have been routed through the order server 224, that have and have not been filled. The servers 222, 224, and 226 may run on the same machine or separate machines. There may be more than one instance of the price server 222, the order server 224, and/or the fill server 226 for gateway 220. In certain embodiments, the additional gateways 220a-220n may each includes instances of the servers 222, 224, and 226 (individually identified as servers 222a-222n, 224a-224n, and 226a-226n).

The gateway 220 may communicate with the exchange 230 using one or more communication networks. For example, as shown in FIG. 2, there may be two communication networks connecting the gateway 220 and the exchange 230. The network 204 may be used to communicate market data to the price server 222. In some instances, the exchange 230 may include this data in a data feed that is published to subscribing devices. The network 206 may be used to communicate order data to the order server 224 and the fill server 226. The network 206 may also be used to communicate order data from the order server 224 to the exchange 230.

The exchange 230, which may be similar to the exchange 130 of FIG. 1, includes an order book 232 and a matching engine 234. The exchange 230 may include additional, different, or fewer components. The order book 232 is a database that includes data relating to unmatched trade orders that have been submitted to the exchange 230. For example, the order book 232 may include data relating to a market for a tradeable object, such as the inside market, market depth at various price levels, the last traded price, and the last traded quantity. The matching engine 234 may match contra-side bids and offers pending in the order book 232. For example, the matching engine 234 may execute one or more matching algorithms that match contra-side bids and offers. A sell order is contra-side to a buy order. Similarly, a buy order is contra-side to a sell order. A matching algorithm may match contra-side bids and offers at the same price, for example. In certain embodiments, the additional exchanges 230a-230n may each include order books and matching engines (individually identified as the order book 232a-232n and the matching engine 234a-234n, which may be similar to the order book 232 and the matching engine 234, respectively). Different exchanges may use different data structures and algorithms for tracking data related to orders and matching orders.

In operation, the exchange 230 may provide price data from the order book 232 to the price server 222 and order data and/or fill data from the matching engine 234 to the order server 224 and/or the fill server 226. Servers 222, 224, 226 may process and communicate this data to the trading device 210. The trading device 210, for example, using a trading application, may process this data. For example, the data may be displayed to a user. In another example, the data may be utilized in a trading algorithm to determine whether a trade order should be submitted to the exchange 230. The trading device 210 may prepare and send an order message to the exchange 230.

In certain embodiments, the gateway 220 is part of the trading device 210. For example, the components of the gateway 220 may be part of the same computing platform as the trading device 210. As another example, the functionality of the gateway 220 may be performed by components of the trading device 210. In certain embodiments, the gateway 220 is not present. Such an arrangement may occur when the trading device 210 does not need to utilize the gateway 220 to communicate with the exchange 230, such as if the trading device 210 has been adapted to communicate directly with the exchange 230.

### IV. Example Computing Device

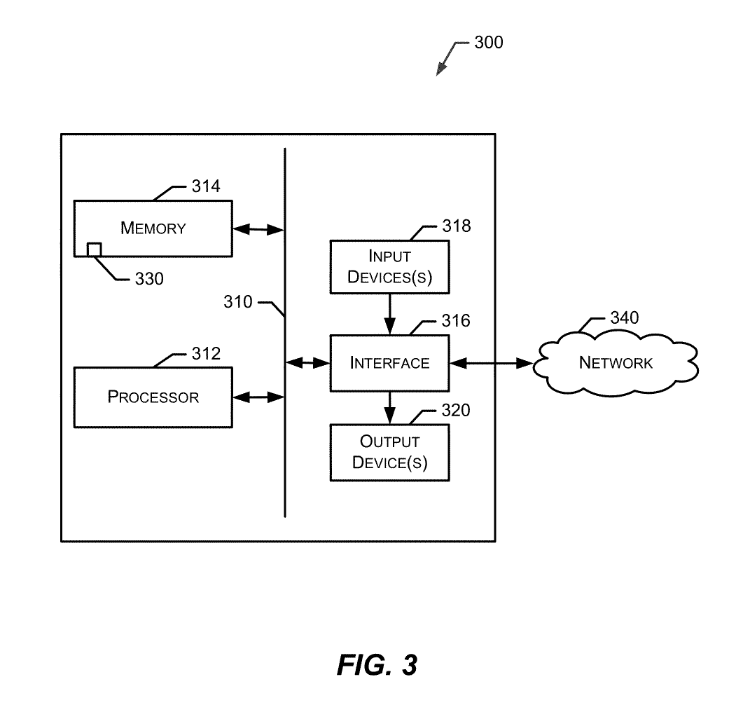

FIG. 3 illustrates a block diagram of an example computing device 300 which may be used to implement the disclosed embodiments. The trading device 110 of FIG. 1 may include one or more computing devices 300, for example. The gateway 120 of FIG. 1 may include one or more computing devices 300, for example. The exchange 130 of FIG. 1 may include one or more computing devices 300, for example.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions which may be executable by the processor 312 or a different processor. The logic may be stored as part of software, hardware, integrated circuits, firmware, and/or micro-code, for example. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media, for example. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, magnetic tape or disk, etc.

The memory 314 may include one or more memory devices. For example, the memory 314 may include local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions which are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

### V. Example Systems and Methods for Multi-Party Trade Order Entry

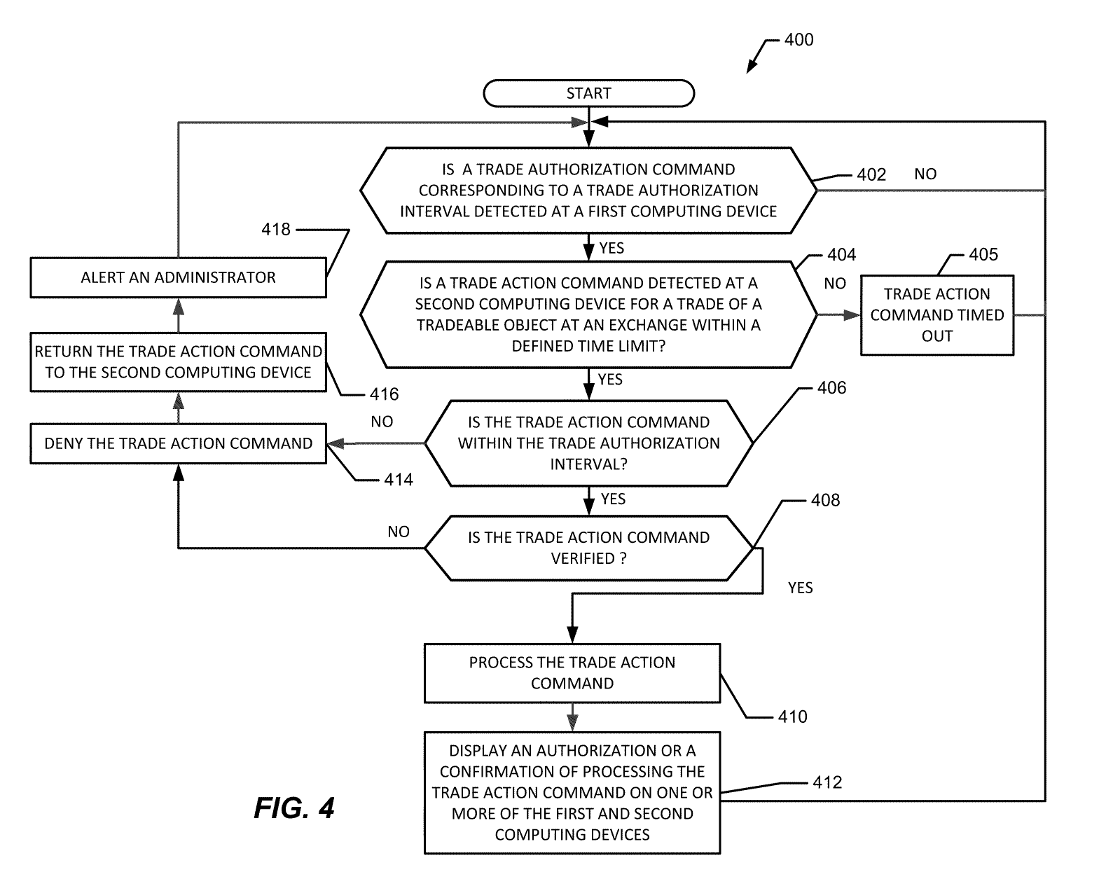

FIG. 4 is a flow diagram representative of example operations that can be executed to implement the teachings of this disclosure. The example operations of FIG. 4 can be implemented by, for example, the example trading device 110 of FIG. 1 and/or the example trading devices 210, 210a-210n of FIG. 2. While the example trading device 110 of FIG. 1 is described as executing the example operations of FIG. 4 below, any suitable device can execute the examples operations of FIG. 4. The example operations of FIG. 4 implement multi-party trade order entry by detecting a trade authorization command corresponding to a trade authorization interval, detecting a trade action command, comparing the trade action command to the trade authorization interval to verify the trade action command, and processing the trade action command based on receipt of the trade authorization command and the trade action command, and the verification of the trade action command.

In the example of FIG. 4, a trade action command for a trade of a tradeable object at an exchange is not processed and/or enabled until a trade authorization command for a trade of the tradeable object is detected and/or the trade action command falls within a trade authorization interval. A trade action command may be in a disabled state and require receipt or confirmation of the trade authorization command in order to be submitted, processed and/or transmitted. In particular, receiving the trade authorization command may enable the trade action command to be transmitted to the exchange.

The example process 400 of FIG. 4 begins at block 402 by detecting a trade authorization command at a first computing device. In this example, the trade authorization command is related to a tradeable object at an exchange, and corresponds to and/or is associated with a trade authorization interval. If a trade authorization command is not detected and/or is not detected within the trade authorization interval, the process restarts. A trading application of the example process 400 may generate a user interface including one or more interface windows displaying various authorization commands and/or data such as trade authorization data. In some examples, interface window(s) may display information such that a trader may view other traders and/or select traders (e.g., traders that require approval for trades) to initiate or submit a trade authorization command relating to one or more of the traders. In some examples, the interface window(s) display selectable or definable trade interface windows, in which the trader may view information of the other traders that require approval for transaction(s) and/or an interface to initiate or submit a trade authorization command.

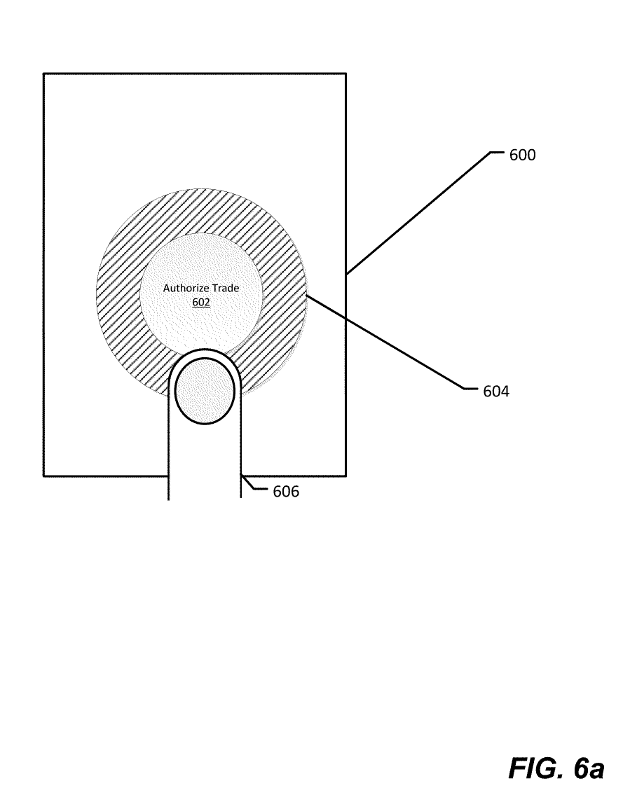

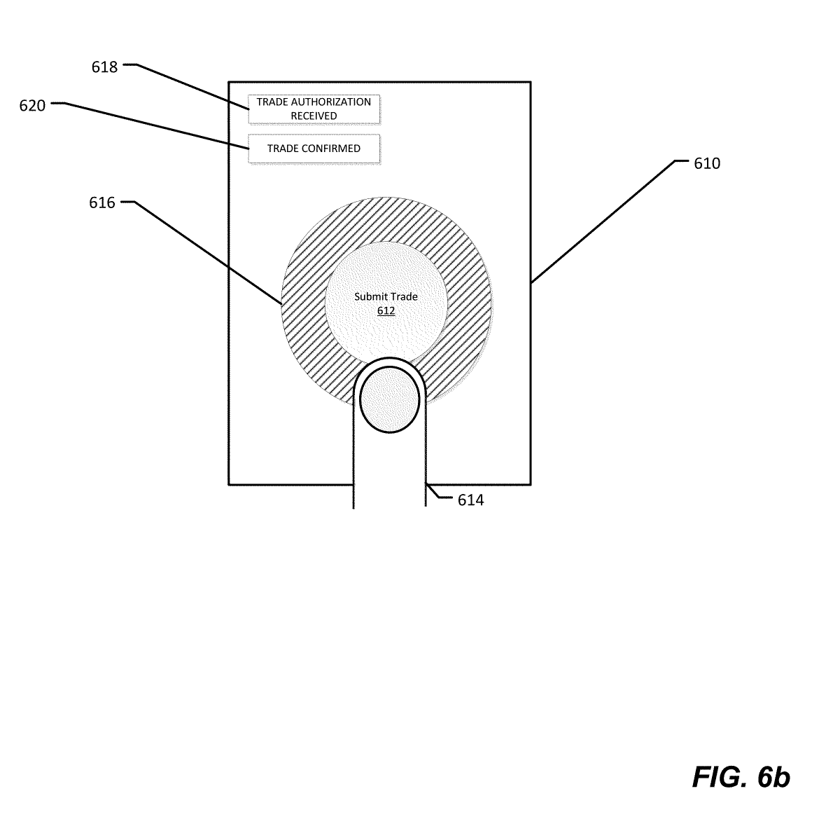

FIG. 6a illustrates an example portion of a trading authorization interface window 600 including a trade authorization command interface (e.g., trade authorization command button) 602 and an indicator 604, all of which may be displayed on the trading device 110, for example. In some examples, the indicator 604 may be an indication of how much time (e.g., a graphical indication of time, etc.) another trader has to submit a trade action command before submittal of the trade action command becomes restricted. In some examples, the trader will need to hold down trade authorization command interface 602 while another trader submits the trade action command on another device in order for the trade action command to be processed. The trade authorization command may be detected by “touching” (e.g., selecting) the trade authorization command interface 602 by a gestural input via, for example, a finger, a stylus, a mouse, a pen, etc. Additionally or alternatively, a finger 606 of the trader may need to be placed on the trade authorization command for a time greater than a threshold time (e.g., five seconds) to submit or initiate the trade authorization command. In some examples, the indicator 604 serves to inform the trader that he or she has activated (e.g., a command has been detected, etc.) the trade authorization command. In some examples, the trader may select numerous other traders. In yet other examples, the trader may select a group of other traders simultaneously.

At block 404, it is determined whether a trade action command is detected at a second computing device within a defined time limit. The trade action command is related to the trade of the tradeable object at the exchange. For example, a trade action command such as a BUY order may be selected by a trader using the second computing device via a touch-screen. FIG. 6b illustrates an example trading interface window 610 including an example trade action command interface (e.g., trade action command button, submit trade button, etc.) 612, which may be displayed on the trading device 110, for example. The trade action command may be detected by “touching” (e.g., selecting) the trade action command interface 601 by a gestural input via, for example, a finger, a stylus, a mouse, a pen, etc. In the illustrated example of FIG. 6b, the trade action command is detected and/or initiated by the trader touching the trade action command interface 612 with a finger 614 and/or holding the finger 614 over the trade action command interface 612 for a period of time. In some examples, an indicator 616 may be used to indicate that the trade action command interface 612 is authorized via the trade authorization command and/or to graphically indicate a time in which the trade action command interface has to be detected due a time limit imposed after the trade authorization command has been detected at the first computing device, for example. If the trade action command is not detected within the defined time limit, the trade action command times out (block 405) and the process restarts. Otherwise, if the trade action command is detected within the time limit (e.g., within a defined time period of the trade authorization command, etc.), the process proceeds to block 406.

At block 406, it is determined whether the trade action command is within the trade authorization interval by comparing the trade action command to the trade authorization interval. In some examples, the verification may be a verification of a trade authorization condition. For example, verification is made via the trade authorization interval (e.g., the trade authorization condition of this example), which is a time period after the trade authorization command is detected or received, in which the trade action command must be detected or received. For example, a first trader may interact with a first user control interface at a first computing device to submit the trade authorization command. In order for the trade action command to be processed, the trade action command, in some examples, must be detected within a defined time period after the trade authorization command has been detected. In some examples, the trade authorization interval requires a temporal overlap between detection of the trade authorization command and detection of the trade action command. In other words, the trade authorization command detection must overlap the trade action command detection in order for the trade action command to be processed and/or sent to an exchange to be processed. In some examples, the trade authorization interval is not time-based. In some examples, the trade authorization interval is a limitation on a number of trades and/or limitation(s) on the types of trades, etc. In some examples, the first and second computing devices are also verified to be within a certain proximity (e.g., within a defined maximum distance) of one another. In some examples, the trade authorization interval requires that the trade action command and the trade authorization command match. If the trade action command is not within the trade authorization interval, the process proceeds to block 414. Otherwise, if the trade action command is within the trade authorization interval, the process proceeds to block 408.

At block 408, if the trade action command is verified (e.g., determined to be within the trade authorization interval), the process proceeds to the block 410, where the trade action command is processed. In some examples, the trade action command is processed by the trade action command being transmitted to the exchange (e.g., the exchange 130 or the exchanges 230a, 230n) and/or the first computing device transmitting a message to the exchange permitting the trade action command.

At block 412, an authorization and/or confirmation of processing the trade action command is displayed on the first computing device and/or the second computing device. Once the authorization and/or confirmation is displayed on one of the computing devices, the process proceeds to the block 402. In the illustrated example of FIG. 6b, the example trading window 610 includes an indicator 616 to indicate how much time (e.g., a graphical indication of time, etc.) another trader has to submit a trade action command before submittal of the trade action command becomes restricted. The example trading interface window 610 also includes an indicator 618 to alert the trader that a trade authorization has been received and/or that a trade authorization period is in session. In some examples, the indicator 618 may also indicate a time limit in which the trade action command must be submitted and/or received. In some examples, the indicator 618 may indicate limitations (e.g., limitations defined by or related to the trade authorization command) such as the number of trades authorized and/or specific limitations of the trade authorization, etc. The trading interface window 610 of the illustrated example also includes a trade confirmation indicator 620 to alert the trader that the trade action command submitted via the trade action command interface 612 has been confirmed or processed.

If, at block 408, the trade action command is determined not to be within the trade authorization interval, the process proceeds to the block 414, where the trade action command is denied.

At block 414, in response to the trade action command not being within the trade authorization interval, the trade action command detected at the second computing device is denied. Additionally, an alert may be generated on the first computing device and/or the second computing device to indicate that the trade action command is not within the trade authorization interval. In some examples, the denied trade action command request is deleted after not falling within the trade limit authorization.

At block 416, in some examples, the request for the denied trade action command is returned to the second computing device and/or the first computing device to allow the trade action command to be resubmitted and/or modified to conform to the trade authorization interval. For example, the denied trade action may be indicated on the trading interface window 610.

At block 418, an administrator may be alerted if the trade action command does not fall within the trade authorization interval, the trade action command has been denied and/or the trade action command has been returned to the second computing device. Such an alert may be transmitted via a network such as the network 340 of FIG. 3, or a gateway such as the gateway 120 described above in connection with FIG. 1, and/or the gateways 220a, 220n described above in connection with FIG. 2.

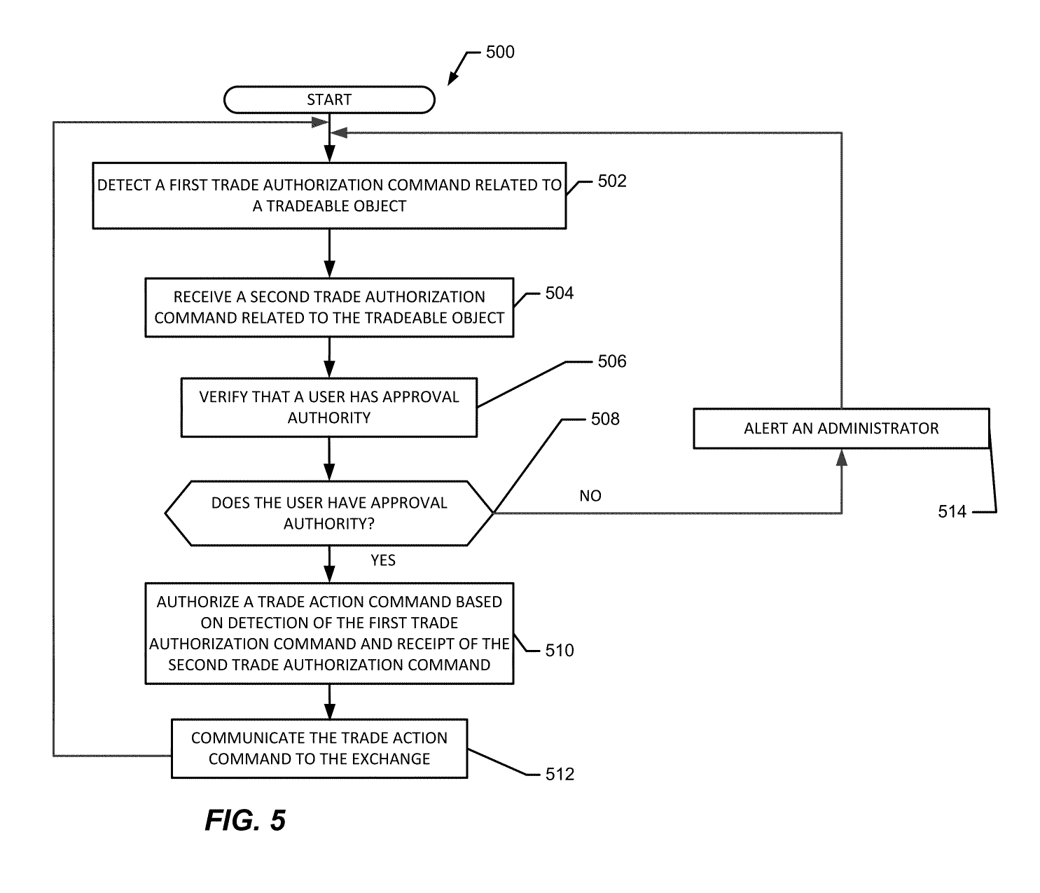

FIG. 5 is another flow diagram representative of example operations of a method 500 that can be executed to implement the teachings of this disclosure. The example operations of FIG. 5 can be implemented by, for example, the example trading device 110 of FIG. 1 and/or the example trading devices 210, 210a-210n of FIG. 2. While the example trading device 110 of FIG. 1 is described as executing the example operations of FIG. 5 below, any suitable device can execute the examples operations of FIG. 5. The example operations of FIG. 5 implement multi-party trade order entry by detecting, at a first computing device, a first trade authorization command related to a tradeable object at an exchange, receiving, at the first computing device, a second trade authorization command related to the tradeable object, authorizing a trade action command based on the detection of the first trade authorization command and receipt of the second trade authorization command, and communicating, by the first computing device, the trade action command or authorization of the trade action command to the exchange.

In the example of FIG. 5, a trade action command related to a tradeable object at an exchange is not authorized, processed and/or enabled until the first trade authorization command related to the tradeable object is detected (e.g., a first activation event) and the second trade authorization command related to the tradeable object is received or detected (e.g., a second activation event). A trade action command may be in a disabled state and require reception or detection of the first and second trade authorization commands in order for the trade action command to be submitted, processed and/or transmitted. In other examples, the trade action command and/or processing of the trade action command transmitted to a gateway/router/exchange may be disabled until reception or detection of the first and second trade authorization commands. For example, receiving the first and second trade authorization commands may enable the trade action command to be transmitted to the exchange.

Referring to the user interface of FIG. 6a described above in connection with FIG. 4, the example process 500 of FIG. 5 begins at block 502 by detecting the first trade authorization command related to tradeable object at the first computing device.

At block 504, the second trade authorization command of the illustrated example is received from the second computing device at the first computing device. In some examples, in order for the trade action command to be processed and/or authorized, the second trade authorization command must be received within a defined time interval (e.g., a time period, time limit, etc.) relative to the first trade authorization command being detected. In other examples, while the first trade authorization command is detected at the first computing device, the second trade authorization command is simultaneously received from the second computing device (e.g., the first and second trade authorization commands overlap) in order for the trade action command to be processed.

At block, 506, in some examples, a user of the first or second computing device is verified to have approval authority. In this example, one or more of the users of the first and computing devices is verified to have approval authority to approve the trade action command. In some examples, the approval authority is verified based on login information at the first computing device and/or the second computing device. In some examples, the approval authority of the user of the first and/or second computing devices may be queried at a server (e.g., the server 212a, etc.) and/or via a gateway (e.g., one of the gateways 120, 220a, 220n, etc.).

At block 508, if one or more of the users is determined to have approval authority, the process proceeds to the block 510, where a trade action command is authorized. In this example, if one or more of the user is determined not to have approval authority, the process proceeds to the block 514, in which an administrator is notified that one or more of the users does not have approval authority. Once the administrator has been notified, the process proceeds to the block 502.

At block 510, the trade action command of the illustrated example is authorized based on detection of the first trade action command and reception of the second trade action command at the first computing device. In some examples, the authorization requires simultaneous detection of the first trade action command and reception or detection of the second trade action command (e.g., an overlap between detection of the first trade action command and reception of the second trade action command).

At block 512, the trade action command is communicated to the exchange. In this example, the trade action command is communicated to the exchange by the first computing device after the trade action command has been authorized. The trade action command may be communicated via a gateway such as the gateway 120 shown in FIG. 1.

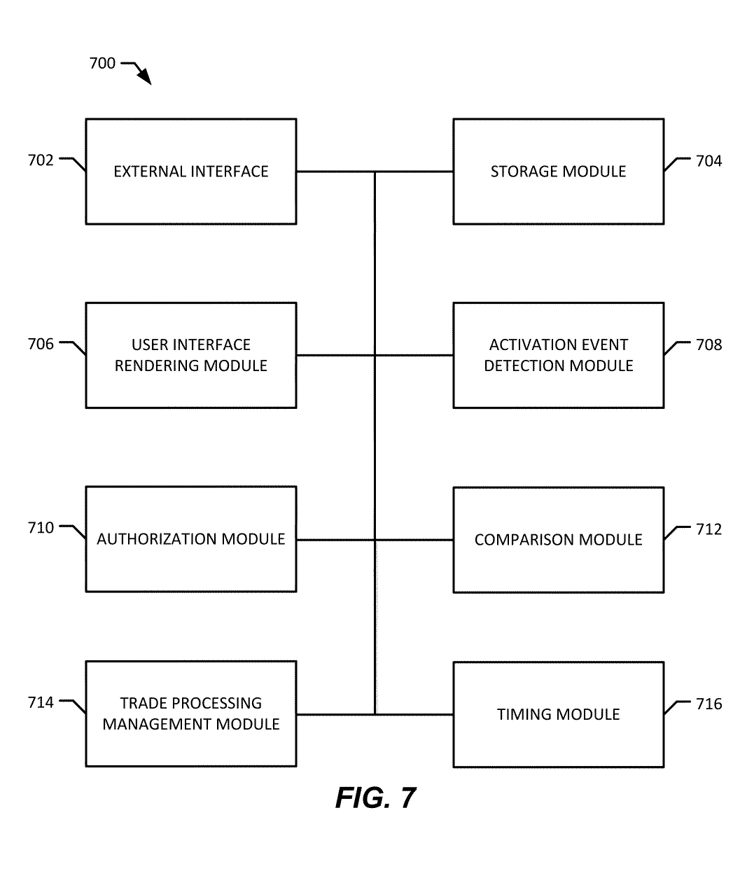

FIG. 7 is a block diagram of an example system 700 that may implement and/or execute the example operations of FIGS. 4 and 5. In some examples, the system 700 may be implemented as part of software (or an application) associated with the trading device 110 of FIG. 1, the gateway 120 of FIG. 1 and/or the electronic exchange 130 of FIG. 1. In some examples, the system 700 may be implemented as computer implemented code or instructions operable independent of software associated with the trading device 110 of FIG. 1, the gateway 120 of FIG. 2 and/or the electronic exchange 130 of FIG. 1. In some examples, the features and functionality of the system 700 may be implemented in hardware operable in connection with the trading device 110 of FIG. 1, the gateway 120 of FIG. 1 and/or the electronic exchange 130 of FIG. 1.

The example system 700 of FIG. 7 includes an external interface 702, an example storage module 704, an example user interface rendering module 706, an example activation event detecting module 708, an authorization module 710, a comparison module 712, an example trade processing management module 714 and an example timing module 716. The external interface 702 of the illustrated example operates as a communication pathway for the trade authorization commands and/or the trade action commands. The trade external interface 702 may communicate the trade action command and/or the trade authorization command between one or more computing devices by receiving user input via, for example, the trading device 110 of FIG. 1. In some examples, the external interface 702 may receive trade action commands and/or trade authorization command from the gateway 120 of FIG. 1 and/or an intermediary component. The trade authorization commands and/or the trade action commands may be communicated between the gateway 120 and the trading device 110. In particular, a junior trader may send the trade action command to the gateway 120 via the trading device 110 or the trading device 210 for a tradeable objecting being traded at a tradeable exchange. In some examples, the external interface 702 receives trade action commands from the junior trader via the trading device 110 or the trading device 210, for example, and/or trade authorization commands from a senior trader or risk administrator via the trading device 110 or the trading device 210a, for example, and stores the commands in an example storage module 704. Additionally or alternatively, user authorization data and/or trader data is stored in the storage module 704. In some examples, the junior trader and the senior trader or risk administrator both interface with the trading device 110. The example storage module 704 may be implemented with any number and/or type(s) of tangible storage medium(s), memory(-ies), memory device(s) and/or memory disc(s).

The example user interface rendering module 706 of the example system 700 renders the displayed user interface. For example, the user interface rendering module 706 generates a user interface including one or more trade action controls or trade authorization interfaces such as the display(s) of the trading device 110 and/or the trading devices 210, 210a-210n to communicate the interfaces and/or the status(es) of the trade action command(s) and/or the trade authorization command(s). In some examples, the user interface rendering module 706 updates a portion of the user interface. For example, the user interface rendering module 706 may display a status of a trade authorization command or a trade action command to a user such as the junior trader using the trading device 110 or the trading device 210, or the senior trader using the trading device 210a, for example. Additionally, when the trade action command and/or the trade authorization command is received via the external interface 702, the user interface rendering module 706 may update the relevant portions of the user interface.

The example activation event detecting module 708 of the example system 700 detects activation events (e.g., detections, detection events, etc.) based on user interactions detected on a touch-screen of the trading device 110, the trading device 210, and/or the trading devices 210a-210n. In some examples, the activation events include directly or indirectly interacting with components (e.g., trade action or trade authorization controls) displayed in the trading interface window rendered by the user interface rendering module 706. In some examples, the activation event detecting module 708 identifies the gestural input (e.g., selecting, holding, swiping, scrubbing, sweeping, etc.) corresponding to the activation event, which may be a trade authorization command or a trade action command. For example, interacting with a user interface by touching a portion of a touch screen such as the examples described above in connection with FIGS. 6a and 6b may result in an activation or detection events that correspond to a trade authorization command or a trade action command.

The example authorization module 710 of the example system 700 verifies credentials of traders logged onto the trading devices 110, 210, and/or the trading devices 210a-210n and/or stores or defines a trade authorization interval (e.g., a trading window, a trade limit period and/or a time interval). For example, the authorization module 710 may verify the credentials (e.g., approval authority, trade authority, etc.) of the senior trader using the trading device 210a or the trading device 110, for example. In some examples, the authorization module 710 queries an external database, via the external interface 702, containing trade authorization interval data, user authorization information and/or trade authorizations, which may be provided to the trade processing management module 714. In the illustrated example of FIG. 7, the authorization module 710 sends a message including authorization information and/or authorization status to the trading device 110, the trading device 210, and/or the trading devices 210a-210n.

The comparison module 712 of the example system 700 determines whether the trade action command identified by the activation event detecting module 708 is verified and/or authorized based on comparing the trade action command to the trade authorization interval defined by the authorization module 710. This comparison may be time-based and occur through use of the timing module 716 in which the timing module 716 provides timing information regarding times when the trade authorization command and/or the trade action command were detected, submitted and/or received. In particular, the timing module may compare and/or calculate a time difference of a trade authorization command submitted by a senior trader at a device 210, and a trade action command submitted by a junior trader at a device 210a, for example, to determine a time difference (e.g., time differential) between the trade authorization command and the trade action command. In some examples, the timing module 716 may use time recordings (e.g., time stamps, etc.) of the trade action command and/or trade authorization command from the gateways 120, 220a, 220n. In some examples, the comparison module 712 may use a data structure such as a lookup table based on the trade authorization interval received from the authorization module 710. In such examples, the comparison module 712 compares the results returned from the data structure to determine whether the trade action command falls within the trade authorization interval. Based on this comparison, the comparison module 712 sends a message to the user interface rendering module 706 and/or the trade processing management module 714.

The example trade processing management module 714 manages the state of one or more of the trade action commands and/or trade authorization commands. For example, the trade processing management module 714 may enable the trade action command of a tradeable object at an exchange to be processed and/or sent to the exchange such as the exchange 130 of FIG. 1 for processing. Additionally or alternatively, the trade processing management module 714 may store the state of the one or more trade action commands and/or trade authorization commands in a data structure. When a message is received from the comparison module 712 and/or the authorization module 710, the trade processing management module 714 updates the status of the trade action command and/or sends the trade action command to an exchange via the external interface 702 for processing based on the message(s) received from the authorization module 710 and/or the comparison module 712. In particular, the trade processing management module 714 may receive a message from the authorization module 710 or the comparison module 712 when a trade action command falls within or conforms to the trade authorization interval. In some examples, the trade processing management module 714 determines what indications or notices are to be provided to the user via the interface rendering module 706. For example, detection of a trade authorization command may signal the trade processing management module 714 to send a message to the user interface rendering module 706. In some examples, detecting and/or receiving the trade authorization command and the trade action command within the trade authorization interval causes the trade processing management module 714 to execute and/or authorize the trade action command. Additionally, the trade processing management module 714 may require verification that a user such as the senior trader issuing the trade authorization command on the device 210, for example, has approval authority to execute and/or authorize the trade action command.

In some examples, the example trade processing management module 714 may receive a timer expiration message from the example timing module 716 based on a time differential between the trade authorization command and the trade action command being greater than a defined time threshold and, thus, not process the trade action command. The example timing module 716 of the illustrated example includes a clock, which may time stamp events such as when, for example, a trade authorization command is detected or received. In some examples, a timer of the example timing module 716 may be initiated to define a time period after the trade authorization command is initiated, detected or received, in which the trade action command must be detected or received in order for the trade action command to be processed. If the timer expires without the trade action command being detected or received within the time period, the timing module 716, in some examples, sends a message to the example trade processing management module 714 that the trade action command was not detected or received within the defined time period.

In an example scenario, junior trader Joe would like to trade (e.g., purchase) 100 units of tradeable object X at an exchange. In this example scenario, junior trader Joe has less than one year of experience and, thus junior trader Joe will require approval and/or authorization from senior trader Bob, who has been assigned approval authority over junior trader Joe. In this example, senior trader Bob interacts with a user interface (e.g., the trade authorization command interface 602 of the trading authorization window 600 of FIG. 6a) to input (e.g., enter) a trade authorization command on the trading device 210, which communicates with the external interface 702 (e.g., one or more of the gateways 120, 220a, 220n). In this example, the user interface is rendered by the user interface rendering module 706. Within five minutes of senior trader Bob inputting the trade authorization command, junior trader Joe, who is using the trading device 210a, inputs a trade action command (e.g., the purchase of 100 units of tradeable object X) into a user interface (e.g., the trade action command interface 612 of the trading interface window 610). The trade action command of this example is also communicated to the external interface 702. I

After both the trade authorization command and the trade action command have been entered by senior trader Bob and junior trader Joe, respectively, the authorization module 710 verifies the credentials of senior trader Bob by verifying login information and/or credentials at the trading device 210. Once, senior trader Bob's credentials have been verified, the trade authorization command and the trade action command are sent to the comparison module 712. In this particular example, the comparison module 712 calculates a difference in time between the trade action command and the trade authorization command via time stamps provided by the timing module 716, for example. In this example, the comparison module 712 verifies that the trade action command has been submitted or detected within a time threshold (e.g., five minutes) of the trade authorization command being submitted or detected.

In this example scenario, the trade action command for the purchase of 100 units tradeable object X was submitted within five minutes of the trade authorization command and, thus, the comparison module 712 sends a message to the trade processing management module 714, which in turn, processes the trade action command based on the message provided by the comparison module. In this example, the trade action command is processed by the trade processing management module 714 sending a message to the exchange via the external interface 702. In this example, the user interface rendering module 706 updates the status of the trade action command on the trading authorization interface window 600 on the trading device 210 and the trade action command interface 612 of the trading device 210a indicating successful processing of the trade action command to purchase 100 units of tradeable object X.

Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

What is claimed is:

1. A method comprising:
detecting a trade authorization command at a first computing device, the trade authorization command corresponding to a trade authorization interval, the trade authorization interval related to a tradeable object offered at an exchange;
detecting a trade action command at a second computing device related to the tradeable object;
comparing the trade action command to the trade authorization interval to verify the trade action command; and
processing the trade action command based on receipt of the trade authorization command and the trade action command, and the verification of the trade action command.

2. A method as defined in claim 1, wherein the trade authorization interval comprises an overlap in time of the trade authorization command and the trade action command.

3. A method as defined in claim 1, wherein the trade authorization interval comprises a time limit after the trade authorization command in which the trade action command is to be transmitted or received.

4. A method as defined in claim 3, further comprising displaying the time limit on the second computing device.

5. A method as defined in claim 1, wherein the trade authorization interval comprises a number of trade actions that are permitted.

6. A method as defined in claim 1, further comprising displaying an authorization or a confirmation of processing the trade action command on one or more of the first and second computing devices.

7. A method as defined in claim 1, further comprising verifying that the first and second computing devices are within a certain proximity of one another.

8. A method as defined in claim 1, wherein comparing the trade action command to the trade authorization interval occurs on the first computing device.

9. A method as defined in claim 1, further comprising returning the trade action command to the second computing device when the trade action command is not within the trade authorization interval.

10. A method comprising:
detecting, by a first computing device, a first trade authorization command, wherein the first trade authorization command relates to a tradeable object offered at an exchange;
receiving, at the first computing device, a second trade authorization command related to the tradeable object;
authorizing a trade action command based on the detection of the first trade authorization command and receipt of the second trade authorization command; and
communicating, by the first computing device, the trade action command or authorization of the trade action command to the exchange.

11. A method as defined in claim 10, wherein the first trade authorization command is based on a first activation event on the first computing device, and the second trade authorization command is based on a second activation event on a second computing device.

12. A method as defined in claim 11, further comprising verifying that a first user of the first computing device or a second user of the second computing device has approval authority.

13. A method as defined in claim 10, wherein authorizing the trade action command further comprises verifying that the detection of the first trade authorization command and the reception of the second trade authorization command overlap in time.

14. A method as defined in claim 13, wherein the overlap in time is based on first and second activation events from first and second users respectively.

15. A method as defined in claim 10, wherein authorizing the trade action command further comprises verifying that the second trade authorization command is equal to or below a threshold number of permitted trades.

16. A method as defined in claim 10, wherein authorizing the trade action command further comprises verifying that reception of the second trade authorization command occurs within a certain time limit after the detection of the first trade authorization command.

17. A method as defined in claim 10, further comprising alerting an administrator if the trade action command is not authorized.

18. A tangible machine readable medium having instructions stored thereon, which when executed, cause a machine to:
detect a first trade authorization command, wherein the first trade authorization command relates to a tradeable object offered at an exchange;
receive or detect a second trade authorization command related to the tradeable object offered at the exchange; and
authorize a trade action command based on the detection of the first trade authorization command and the reception or detection of the second trade authorization command, and verification of a trade authorization condition.

19. A machine readable medium as defined in claim 18, wherein the trade authorization condition comprises one or more of the following:
the first trade authorization command and the second trade authorization command have an overlap in time,
the first and second trade authorization commands occur within a certain time period relative to one another, or
one or more of the first and second trade authorization commands is within defined trade limitations.

20. A machine readable medium as defined in claim 18, which when executed, further cause a machine to communicate one or more of the trade action command or authorization of the trade action command to the exchange.
